(19) United States
(12) Patent Application Publication
(10) Pub. No.: US 2025/0322375 A1
(43) Pub. Date: Oct. 16, 2025

(54) SYSTEMS AND METHOD FOR NETWORK-BASED DELIVERY OF DYNAMIC CONTENT

(71) Applicant: JPMORGAN CHASE BANK, N.A., New York, NY (US)

(72) Inventors: Howard SPECTOR, Street, MD (US); Sridhar ARAVAMUDHAN, Middletown, DE (US); Louis CULOT, Brooklyn, NY (US); Edward OLEBE, New Paltz, NY (US); Chris CONRAD, Philadelphia, PA (US); Emi ALEXANDER, New Canaan, CT (US)

(21) Appl. No.: 18/632,988

(22) Filed: Apr. 11, 2024

(51) Int. Cl. G06Q 20/20; G06Q 20/32; G06Q 20/40

(52) U.S. Cl. CPC G06Q 20/20; G06Q 20/3224; G06Q 20/4097

(57) ABSTRACT

Systems and methods for network-based delivery of dynamic content are disclosed. A method may include: receiving, by a network computer program, a location for a customer electronic device associated with a customer; determining, by the network computer program and from the location, that the customer is within a predetermined distance of a merchant; requesting, by the network computer program, content for one or more payment card issued by an issuer to the customer from an issuer backend for the issuer; receiving, by the network computer program, the content; and communicating, by the network computer program, the content to a merchant backend for the merchant. The merchant backend receives, from a merchant point of sale device, payment card information for one of the payment cards, retrieves the content for the payment card, and causes the merchant point of sale device to display the content on a display.

### BACKGROUND OF THE INVENTION

### 1. Field of the Invention

Embodiments generally relate to systems and methods for network-based delivery of dynamic content.

### 2. Description of the Related Art

Over the past few years, the customer checkout process has changed considerably. Point of sale devices are often provided with large displays that convey information, such as pricing information, a running total, to the customer.

### SUMMARY OF THE INVENTION

Systems and methods for network-based delivery of dynamic content are disclosed. According to an embodiment, a method for network-based delivery of dynamic content may include: (1) receiving, by a network computer program, a location for a customer electronic device associated with a customer; (2) determining, by the network computer program and from the location, that the customer is within a predetermined distance of a merchant; (3) requesting, by the network computer program, content for one or more payment card issued by an issuer to the customer from an issuer backend for the issuer; (4) receiving, by the network computer program, the content; and (5) communicating, by the network computer program, the content to a merchant backend for the merchant. The merchant backend may be configured to receive, from a merchant point of sale device, payment card information for one of the payment cards, to retrieve the content for the payment card, and to cause the merchant point of sale device to display the content on a display.

In one embodiment, the content may be encrypted with a shared secret and a portion of the payment card information, and the merchant backend decrypts the content with the shared secret and the portion of the payment card information. The portion of the payment card information may include issuer discretionary data for the payment card.

In one embodiment, the content may include interactive content having a plurality of options, and the method further may include: receiving, by the network computer program, a selection of one of the plurality of options from the merchant point of sale device that was selected by the customer; and communicating, by the network computer program, the selection to the issuer backend.

In one embodiment, the method may also include periodically polling, by the network computer program, the customer electronic device for the location.

In one embodiment, the method may also include deleting, by the network computer program, the content after a predetermined condition. The predetermined condition may include a time condition or a customer electronic device location condition.

According to another embodiment, a system may include: a payment network comprising a network computer processor executing a network computer program; a merchant system comprising a merchant backend, a merchant point of sale device comprising a display, and a merchant content cache; an issuer system for an issuer comprising an issuer backend and an issuer content database; and a customer electronic device associated with a customer. The network computer program receives a location for the customer electronic device; determines from the location that the customer is within a predetermined distance of a merchant location for the merchant; and requests content for one or more payment card issued by the issuer to the customer from the issuer backend. The issuer backend retrieves the content from the issuer content database and communicates the content to the network computer program. The network computer program communicates the content to the merchant backend for the merchant. The merchant backend receives payment card information for one of the payment cards from the merchant point of sale device, retrieves the content for the payment card; and causes the merchant point of sale device to display the content on the display.

In one embodiment, the content may be encrypted with a shared secret and a portion of the payment card information, and the merchant backend decrypts the content with the shared secret and the portion of the payment card information. The portion of the payment card information may include issuer discretionary data for the payment card.

In one embodiment, the content may include interactive content having a plurality of options, and the network computer program receives a selection of one of the plurality of options from the merchant point of sale device that was selected by the customer, and communicates the selection to the issuer backend.

In one embodiment, the network computer program periodically polls the customer electronic device for the location.

In one embodiment, the network computer program deletes the content after a predetermined condition. The predetermined condition may include a time condition or a customer electronic device location condition.

According to another embodiment, a non-transitory computer readable storage medium, including instructions stored thereon, which when read and executed by one or more computer processors, cause the one or more computer processors to perform steps comprising: receiving a location for a customer electronic device associated with a customer; determining, from the location, that the customer is within a predetermined distance of a merchant; requesting content for one or more payment card issued by an issuer to the customer from an issuer backend for the issuer; receiving the content; communicating the content to a merchant backend for the merchant; receiving, from a merchant point of sale device, payment card information for one of the payment card; retrieving, the content for the payment card; and causing the merchant point of sale device to display the content on a display.

In one embodiment, the content may be encrypted with a shared secret and a portion of the payment card information, and the merchant backend decrypts the content with the shared secret and the portion of the payment card information. The portion of the payment card information may include issuer discretionary data for the payment card.

In one embodiment, the content may include interactive content having a plurality of options, and further including instructions stored thereon, which when read and executed by one or more computer processors, cause the one or more computer processors to perform steps comprising: receiving a selection of one of the plurality of options from the merchant point of sale device that was selected by the customer; and communicating the selection to the issuer backend.

In one embodiment, the non-transitory computer readable storage medium may also include instructions stored thereon, which when read and executed by one or more computer processors, cause the one or more computer processors to perform steps comprising: periodically polling the customer electronic device for the location.

In one embodiment, the non-transitory computer readable storage medium may also include instructions stored thereon, which when read and executed by one or more computer processors, cause the one or more computer processors to perform steps comprising: deleting the content after a predetermined condition, wherein the predetermined condition may include a time condition or a customer electronic device location condition.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for network-based delivery of dynamic content according to an embodiment;

FIG. 2 depicts a method for pre-staging dynamic content according to an embodiment;

FIG. 3 depicts a method for delivering dynamic content according to an embodiment;

FIG. 4 depicts an exemplary computing system for implementing aspects of the present disclosure.

### DETAILED DESCRIPTION OF PREFERRED EMBODIMENTS

Embodiments generally relate to systems and methods for network-based delivery of dynamic content.

In embodiments, a network may support the dynamic delivery of content to make the checkout experience more personal. The content may include graphical images, offers for products (e.g., upsells), advertisements, etc. The content may also be interactive so that the issuer or merchant may interact with the customer during checkout. The network may be, for example, an enhanced payment network over which acquirers and merchants may obtain both transaction/payment information and content. In another embodiment, two networks may be provided-a traditional payment network for communication transaction/payment information, and a second network, over which content may be requested and provided.

In embodiments, the network may provide a shared secret to the merchant or the acquirer. The shared secret may be combined with data read from the customer's payment card (e.g., discretionary or optional data provided to the magnetic strip or chip by the card issuer, a card verification value (CVV), etc.) to create the shared secret that is needed to decrypt encrypted data. Thus, content may be encrypted and pre-staged with the merchant, and the merchant or acquirer will not be able to decrypt the data until the customer is engaged in a checkout process and has presented a payment device. For online transactions, a portion of the customer's primary account number (PAN) or card verification value may be used as part of the shared secret.

In one embodiment, the shared secret may be common to more than one merchant, may be unique to one merchant (e.g., each merchant has its own shared secret), may be unique for each customer visit, etc. In one embodiment, the shared secret may be dynamic in that it may change periodically, e.g., daily, hourly, etc., after a certain number of customer visits, etc.

In another embodiment, the point-of-sale device may identify the customer's electronic device before the payment device is presented, using, for example Bluetooth, Geofencing, 5 G, RFID, etc. This may be used to, for example, present information that does not need to be encrypted to the user.

In embodiments, content may also be provided to the merchant. For example, during the checkout process, an image of the customer may be presented to the cashier so that the cashier can confirm the customer's appearance. In addition, an image of the customer's payment device may be presented, so the cashier may confirm that the customer's card is authentic. In another embodiment, the customer's government identification (e.g., a driver license) may be presented for age verification, etc.

Other examples of content may include notifications, such as a number of points earned (e.g., “You earned 1000 points with this purchase), a distance from a goal (e.g., “You are two purchases away from your next reward”), offers (e.g., “Save 10% on your next purchase with this card”), payment options (e.g., “Do you want to split payment for this transaction into four monthly payments?”), etc. This content may be presented on the display at the point of sale, or they may be communicated to the customer's electronic device (e.g., smartphone).

In embodiments, the customer's electronic device and the point-of-sale device may interact to create custom customer experiences, such as communicating applicable coupons or offers from an issuer application to the point-of-sale device for use in the checkout process.

In embodiments, the merchant may be able to push messages to customers using the network. These messages may be text or push messages delivered via the issuer's application, the network's application, etc.

In embodiments, purchase order, SKU, and other data may be dynamically defined and passed bi-directionally in the system. For example, information on the goods or services being purchased may be used to identify and provide dynamic coupons or offers, financing programs, etc.

Embodiments may provide the user with the ability to upgrade the payment card presented to the point-of-sale device to one that provides better customer benefits. For example, the user may be offered a payment card that may provide higher rewards, lower interest rate, product insurance, etc. Embodiments may provide the terms and conditions to the point-of-sale device.

In embodiments, certain merchants may provide detailed account information on the point-of-sale device based on on-line linking performed by the customer.

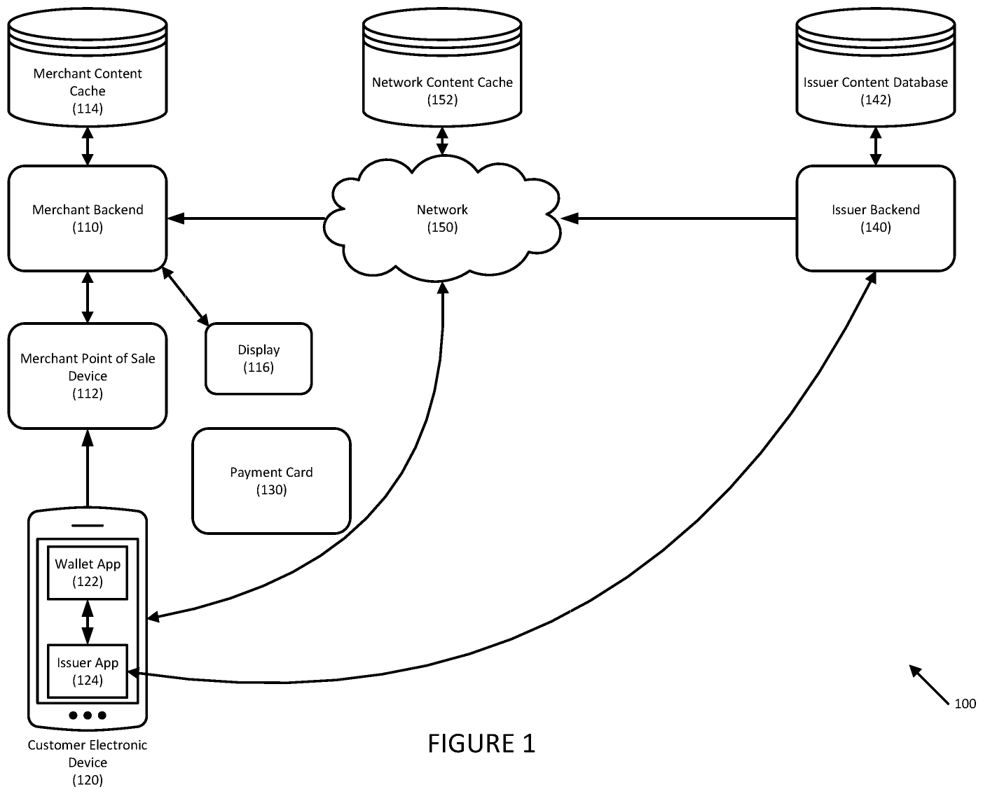

FIG. 1 depicts a system for network-based delivery of dynamic content according to an embodiment. System 100 may include a merchant, which may include merchant backend 110, merchant point-of-sale device 112, and merchant content cache 114. In one embodiment, merchant backend 112 and/or merchant point of sale device 112 may be provided with display 116.

Merchant point of sale device 112 may interface with customer electronic device 120. Customer electronic device 120 may be a computer (e.g., workstation, desktop, laptop, notebook, tablet, etc.), a smart device (e.g., smart phone, smart watch, etc.), an Internet of Things (IoT) appliance, etc. Customer electronic device 120 may execute one or more computer programs or applications, including wallet application 122, issuer application 124, etc. Wallet application 122 may store provisioned financial instruments issued by the issuer.

Merchant point of sale device 112 may also interface with payment card 130, which may be a physical payment card (e.g., credit card, debit card, etc.), a payment fob, etc. Payment card 130 may be presented to merchant point of sale device 112 by a swipe, a tap, a dip, etc.

Customer electronic device 120 may include location sensing technology (not shown), such as global positioning system technology. Customer electronic device 120 may communicate its location to network 150 periodically, on demand, etc. In one embodiment, network 150 may periodically poll customer electronic device 120 for its location to determine if it is in proximity to one or more merchant.

Issuer backend 140 may be associated with an issuer of payment cards and may maintain issuer content database 142. Issuer content database 142 may maintain offers, ads, customer-specific information (e.g., reward points, credit limit, current balances, etc.), customer information (e.g., name, image, etc.).

Network 150 may request content from issuer backend 140. Issuer backend 140 may retrieve content (e.g., offers, reward information, customer information, notifications, etc.) from issuer content database 142 and may communicate it to network 150, which may cache the content in network content cache 152. In one embodiment, each content may be associated with a payment card, and may be encrypted using certain information from the payment card (e.g., issuer discretionary information) that may be unique to each payment card.

When customer electronic device 120 is within a certain distance of the merchant, network 150 may communicate encrypted content to merchant backend 110, and the content may be stored in merchant content cache 114. The encrypted content may be for any payment cards that the customer may present for payment. In one embodiment, to reduce storage requirements, historical transaction data for the customer may be used to identify the most likely payment card(s) for the customer to use, and encrypted content for those payment cards may be communicated to merchant backend 110.

In one embodiment, if network 150 does not have content for the payment cards, it may request content from issuer backend 140, and then provide the content to merchant backend 110.

When the customer checks out, the customer may present a payment card using wallet application 122 or by presenting payment card 130. Merchant point of sale device 112 may read the payment card and may retrieve encrypted content for the payment card from merchant content cache 114. It may then use information read from the payment card to decrypt the encrypted content, and to present the content to the customer on a display (not shown).

In one embodiment, content may also be provided to customer electronic device 120 via wallet app 122. This may be in addition to the content displayed on merchant point of sale device 112.

In one embodiment, the content may be interactive, and any responses, selections, etc. from the user may be returned to issuer backend 140 for further processing.

When a deletion criterion is met, such as a certain amount of time has passed, when the customer electronic device 120 is no longer in a close proximity to the merchant point of sale device 120, or when the network determines that the transaction is complete, merchant backend 110 may delete the encrypted content from merchant content cache 114.

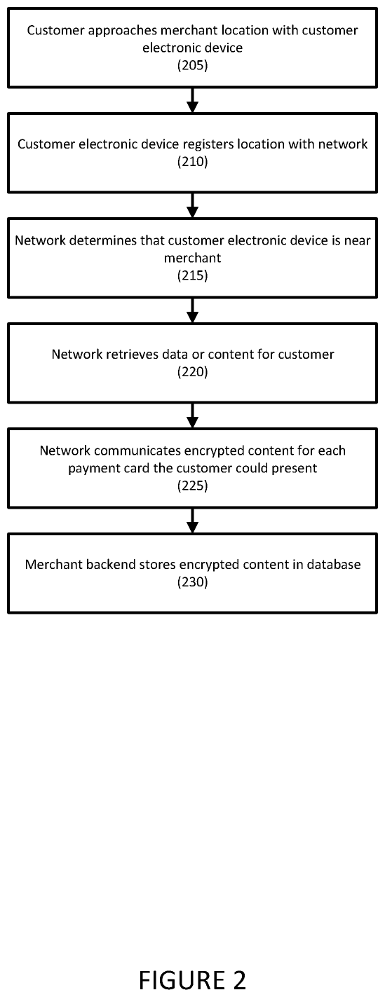

Referring to FIG. 2, a method for pre-staging dynamic content is disclosed according to an embodiment.

In step 205, a customer with a customer electronic device may approach a merchant location.

In step 210, the customer electronic device may send its location to a network dynamically, periodically, sporadically, or randomly. Alternatively or additionally, the network may poll the customer electronic device for its location dynamically, periodically, sporadically, or randomly.

In step 215, the network may determine that the customer electronic device is near a merchant, such as within a predetermined distance of the merchant. The predetermined distance may be set by the network, by the merchant, based on a customer preference, etc.

In step 220, the network may identify all payment cards that the customer is likely to use with the merchant and may retrieve cached content for each payment card. In one embodiment, if there is no cached content, the network may request content from the issuer of the payment card.

In one embodiment, the content may be encrypted with card information, such as issuer discretionary data.

In step 225, the network may communicate the encrypted content for each payment card the customer could present to the merchant backend, and in step 230, the merchant backend may store the encrypted content.

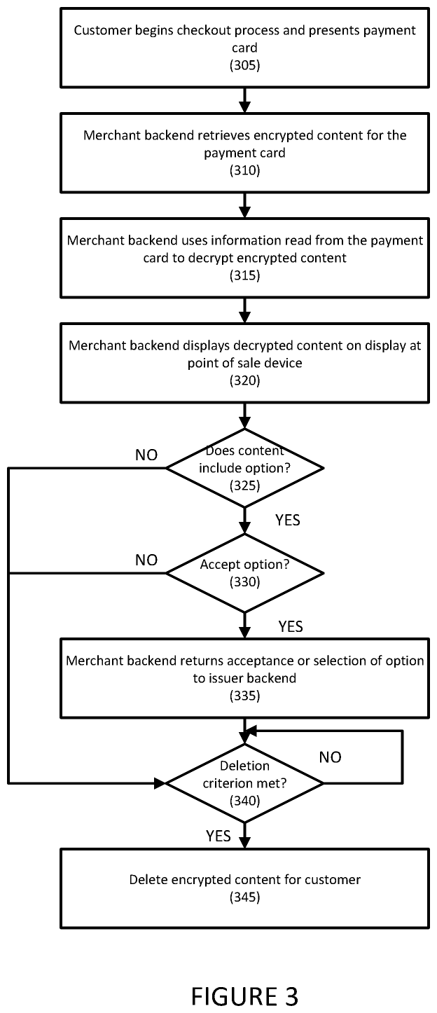

Referring to FIG. 3, a method for presenting dynamic content is provided according to an embodiment.

In step 305, a customer may begin a checkout process with a merchant and may present a payment card to the point-of-sale device.

In step 310, the merchant point of sale device may read the payment card, and the merchant backend may retrieve encrypted content for the payment card. If there is no content pre-staged, the merchant backend may request content from the network, which may then request content from the issuer backend.

In step 315, the merchant backend may use information read from the payment card to decrypt the encrypted content, and in step 320, may cause the decrypted content to be displayed on a display at the point-of-sale device.

In one embodiment, the content may be displayed on the customer's electronic device instead of, or in addition to, being displayed on the display at the point-of-sale device.

In step 325, if the content includes an option, and in step 330, the customer accepts the option, or makes a selection (e.g., use reward points, split the payment into four equal payments, etc.), in step 335, the merchant backend may communicate the acceptance or selection of the option to the issuer backend, and the issuer backend may take an appropriate action.

In step 340, once a deletion criterion is met (e.g., passage of time, customer has left the merchant location, the transaction is complete, etc.), in step 345, the merchant backend may delete the encrypted content for the payment cards associated with the customer.

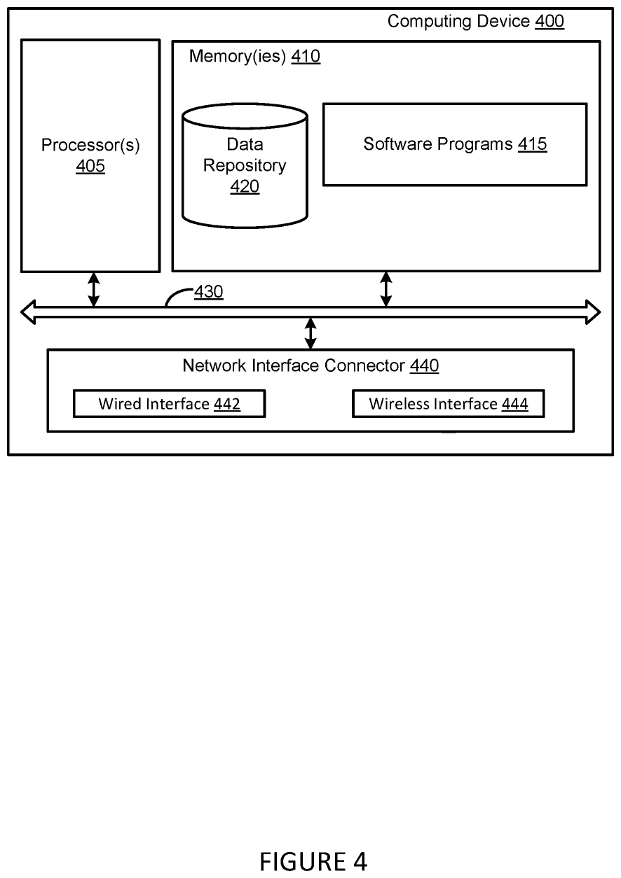

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a network computer program, a location for a customer electronic device associated with a customer;
determining, by the network computer program and from the location, that the customer is within a predetermined distance of a merchant;
requesting, by the network computer program, content for one or more payment card issued by an issuer to the customer from an issuer backend for the issuer;
receiving, by the network computer program, the content; and
communicating, by the network computer program, the content to a merchant backend for the merchant;
wherein the merchant backend is configured to receive, from a merchant point of sale device, payment card information for one of the payment cards, to retrieve the content for the respective payment card, and to cause the merchant point of sale device to display the content on a display.

2. The method of claim 1, wherein the content is encrypted with a shared secret and a portion of the payment card information, and the merchant backend decrypts the content with the shared secret and the portion of the payment card information.

3. The method of claim 2, wherein the portion of the payment card information comprises issuer discretionary data for the payment card.

4. The method of claim 1, wherein the content comprises interactive content comprising a plurality of options, and the method further comprises:
receiving, by the network computer program, a selection of one of the plurality of options from the merchant point of sale device that was selected by the customer; and
communicating, by the network computer program, the selection to the issuer backend.

5. The method of claim 1, further comprising:
polling, by the network computer program, the customer electronic device for the location.

6. The method of claim 1, further comprising:
deleting, by the network computer program, the content after a predetermined condition.

7. The method of claim 6, wherein the predetermined condition comprises a time condition or a customer electronic device location condition.

8. A system, comprising:
a payment network comprising a network computer processor executing a network computer program;
a merchant system comprising a merchant backend, a merchant point of sale device comprising a display, and a merchant content cache;
an issuer system for an issuer comprising an issuer backend and an issuer content database; and
a customer electronic device associated with a customer;
wherein:
the network computer program receives a location for the customer electronic device;
the network computer program determines from the location that the customer is within a predetermined distance of a merchant location for the merchant;
the network computer program requests content for one or more payment card issued by the issuer to the customer from the issuer backend;
the issuer backend retrieves the content from the issuer content database and communicates the content to the network computer program;
the network computer program communicates the content to the merchant backend for the merchant;
the merchant backend receives payment card information for one of the payment cards from the merchant point of sale device;
the merchant backend retrieves the content for the respective payment card; and
the merchant backend causes the merchant point of sale device to display the content on the display.

9. The system of claim 8, wherein the content is encrypted with a shared secret and a portion of the payment card information, and the merchant backend decrypts the content with the shared secret and the portion of the payment card information.

10. The system of claim 9, wherein the portion of the payment card information comprises issuer discretionary data for the payment card.

11. The system of claim 8, wherein the content comprises interactive content comprising a plurality of options, and the network computer program receives a selection of one of the plurality of options from the merchant point of sale device that was selected by the customer, and communicates the selection to the issuer backend.

12. The system of claim 8, wherein the network computer program polls the customer electronic device for the location.

13. The system of claim 8, wherein the network computer program deletes the content after a predetermined condition.

14. The system of claim 13, wherein the predetermined condition comprises a time condition or a customer electronic device location condition.

15. A non-transitory computer readable storage medium, including instructions stored thereon, which when read and executed by one or more computer processors, cause the one or more computer processors to perform steps comprising:
receiving a location for a customer electronic device associated with a customer;
determining, from the location, that the customer is within a predetermined distance of a merchant;
requesting content for one or more payment card issued by an issuer to the customer from an issuer backend for the issuer;
receiving the content;
communicating the content to a merchant backend for the merchant;
receiving, from a merchant point of sale device, payment card information for one of the payment card;
retrieving, the content for the respective payment card; and
causing the merchant point of sale device to display the content on a display.

16. The non-transitory computer readable storage medium of claim 15,
wherein the content is encrypted with a shared secret and a portion of the payment card information, and the merchant backend decrypts the content with the shared secret and the portion of the payment card information.

17. The non-transitory computer readable storage medium of claim 16,
wherein the portion of the payment card information comprises issuer discretionary data for the payment card.

18. The non-transitory computer readable storage medium of claim 15, wherein the content comprises interactive content comprising a plurality of options, and further including instructions stored thereon, which when read and executed by one or more computer processors, cause the one or more computer processors to perform steps comprising:
receiving a selection of one of the plurality of options from the merchant point of sale device that was selected by the customer; and
communicating the selection to the issuer backend.

19. The non-transitory computer readable storage medium of claim 15, further including instructions stored thereon, which when read and executed by one or more computer processors, cause the one or more computer processors to perform steps comprising:
polling the customer electronic device for the location.

20. The non-transitory computer readable storage medium of claim 15, further including instructions stored thereon, which when read and executed by one or more computer processors, cause the one or more computer processors to perform steps comprising:
deleting the content after a predetermined condition, wherein the predetermined condition comprises a time condition or a customer electronic device location condition.
